(19) United States
(12) Patent Application Publication
(10) Pub. No.: US 2024/0185829 A1
(43) Pub. Date: Jun. 6, 2024

(54) METHOD, ELECTRONIC DEVICE, AND COMPUTER PROGRAM PRODUCT FOR SPEECH SYNTHESIS

(71) Applicant: Dell Products L.P., Round Rock, TX (US)

(72) Inventors: Zijia Wang, WeiFang (CN); Zhisong Liu, Shenzhen (CN); Zhen Jia, Shanghai (CN)

(21) Appl. No.: 17/987,034

(22) Filed: Nov. 15, 2022

(30) Foreign Application Priority Data
Oct. 21, 2022 (CN) 202211294423.X

(51) Int. Cl. G10L 13/02; G10L 25/78

(52) U.S. Cl. CPC G10L 13/02; G10L 25/78

(57) ABSTRACT

Embodiments of the present disclosure provide a method, an electronic device, and a computer program product for speech synthesis. The method for speech synthesis includes: extracting a plurality of voice feature vectors of a plurality of speakers from a plurality of audios corresponding to the plurality of speakers; calculating a first loss function based on distances between the plurality of voice feature vectors of the plurality of speakers; calculating a second loss function according to a plurality of texts and a plurality of corresponding real audios; and generating a speech synthesis model based on the first loss function and the second loss function. By implementing the method, the speech synthesis model can be optimized and trained, so that a high-quality audio with target voice features can be outputted based on the texts.

### RELATED APPLICATION

The present application claims priority to Chinese Patent Application No. 202211294423.X, filed Oct. 21, 2022, and entitled “Method, Electronic Device, and Computer Program Product for Speech Synthesis,” which is incorporated by reference herein in its entirety.

### FIELD

Embodiments of the present disclosure relate to the technical field of computers, and in particular to a method, an electronic device, and a computer program product for speech synthesis.

### BACKGROUND

Speech-based communication can provide users with intuitive and convenient services. A technology referred to as text-to-speech (TTS) or speech synthesis is a technology that synthesizes, according to a given text, a desired understandable and natural speech with voice features of a target person in applications that require human voices and without recording a real voice of the person in advance.

Currently, TTS technology is an important research topic in language learning and machine learning, and has a wide range of applications in the industry, such as notification broadcasting, speech navigation, and an artificial intelligence assistant for a terminal. However, the audio output quality of a current speech synthesis model has not achieved an effect comparable to that of natural human voices, and such speech synthesis models therefore need to be optimized and improved urgently.

### SUMMARY

According to example embodiments of the present disclosure, a technical solution of speech synthesis is provided, which is used for optimizing a text-based speech synthesis model.

In a first aspect of the present disclosure, a method for speech synthesis is provided. The method may include: extracting a plurality of voice feature vectors of a plurality of speakers from a plurality of audios corresponding to the plurality of speakers; calculating a first loss function based on distances between the plurality of voice feature vectors of the plurality of speakers; calculating a second loss function according to a plurality of texts and a plurality of corresponding real audios; and generating a speech synthesis model based on the first loss function and the second loss function.

By implementing the method provided in the first aspect, the speech synthesis model can be optimized and trained, so that a high-quality audio with target voice features can be outputted based on the texts.

In some embodiments of the first aspect, the method further includes: inputting a first text and voice features of a first speaker into the speech synthesis model, and outputting a first audio corresponding to the first text.

In some embodiments of the first aspect, the plurality of speakers corresponding to training of the speech synthesis model do not include the first speaker, that is, the first speaker is a stranger, which is not included in training samples of the speech synthesis model.

In some embodiments of the first aspect, the speech synthesis model is generated by training at a cloud, and the first audio, corresponding to the first text, for the first speaker is locally generated. Training is performed through a large number of training samples for the plurality of speakers at the cloud, and the model is finely adjusted for the first speaker at an edge, so that processing resources and processing capabilities in an architecture can be reasonably allocated, and a speech synthesis architecture system at the edge has a small computing quantity and low resource demands, and is easily applied to an edge device.

In a second aspect of the present disclosure, an electronic device for speech synthesis is provided. The electronic device includes: a processor and a memory coupled to the processor.

The memory has instructions stored therein which, when executed by the electronic device, cause the electronic device to perform actions including: extracting a plurality of voice feature vectors of a plurality of speakers from a plurality of audios corresponding to the plurality of speakers; calculating a first loss function based on distances between the plurality of voice feature vectors of the plurality of speakers; calculating a second loss function according to a plurality of texts and a plurality of corresponding real audios; and generating a speech synthesis model based on the first loss function and the second loss function.

By implementing the electronic device provided in the second aspect, the speech synthesis model can be optimized and trained, so that a high-quality audio with target voice features can be outputted based on the texts.

In some embodiments of the second aspect, the actions further include: inputting a first text and voice features of a first speaker into the speech synthesis model, and outputting a first audio corresponding to the first text.

In some embodiments of the second aspect, the plurality of speakers corresponding to training of the speech synthesis model do not include the first speaker, that is, the first speaker is a stranger, which is not included in training samples of the speech synthesis model.

In some embodiments of the second aspect, the speech synthesis model is generated by training at a cloud, and the first audio, corresponding to the first text, for the first speaker is locally generated. Training is performed through a large number of training samples for the plurality of speakers at the cloud, and the model is finely adjusted for the first speaker at an edge, so that processing resources and processing capabilities in an architecture can be reasonably allocated, and a speech synthesis architecture system at the edge has a small computing quantity and low resource demands, and is easily applied to an edge device.

In a third aspect of the present disclosure, a computer program product is provided, and the computer program product is tangibly stored in a computer-readable medium and includes machine-executable instructions, wherein the machine-executable instructions, when executed by a machine, cause the machine to perform the method according to the first aspect of the present disclosure.

In a fourth aspect of the present disclosure, a non-transitory computer-readable storage medium having a computer program stored thereon is provided, wherein the computer program, when executed by a device, causes the device to perform the method according to the first aspect of the present disclosure.

Through the above descriptions, according to the solutions of the various embodiments of the present disclosure, the speech synthesis model can be optimized and trained, so that a high-quality audio with target voice features can be outputted based on the texts.

It should be understood that this Summary is provided to introduce the selection of concepts in a simplified form, which will be further described in the Detailed Description below. The Summary is neither intended to identify key features or main features of the present disclosure, nor intended to limit the scope of the present disclosure.

### BRIEF DESCRIPTION OF THE DRAWINGS

The above and other features, advantages, and aspects of embodiments of the present disclosure will become more apparent in conjunction with the accompanying drawings and with reference to the following Detailed Description. In the accompanying drawings, identical or similar reference numerals represent identical or similar elements, in which:

FIG. 1 shows a schematic diagram of a relationship of potential energy, a resultant force, and a distance;

FIG. 2 shows a flow chart of a method for speech synthesis according to some embodiments of the present disclosure;

FIG. 3 shows a flow chart of another method for speech synthesis according to some embodiments of the present disclosure;

FIG. 4 shows a schematic diagram of an architecture for speech synthesis according to some embodiments of the present disclosure;

FIG. 5 shows a schematic diagram of a training module according to some embodiments of the present disclosure;

FIG. 6 shows a schematic diagram of a voice cloning module according to some embodiments of the present disclosure;

FIG. 7 shows a schematic diagram of a cloned audio generation module according to some embodiments of the present disclosure; and

FIG. 8 shows a block diagram of a device that can be configured to implement embodiments of the present disclosure.

### DETAILED DESCRIPTION

Illustrative embodiments of the present disclosure will be described in more detail below with reference to the accompanying drawings. Although the accompanying drawings show some embodiments of the present disclosure, it should be understood that the present disclosure can be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the protection scope of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

When a large number of high-quality single speaker recordings are used for training, a text-to-speech synthesis model can usually synthesize a natural human voice. The text-to-speech synthesis model can be extended to an application scenario with a plurality of speakers. The purpose of text-to-speech synthesis of a customized voice service is to use a source text-to-speech synthesis model and a small number of speeches of a target speaker to synthesize a speech with personal voice features of the target speaker. However, if the plurality of speakers training the source text-to-speech synthesis model do not include the target speaker, the source text-to-speech synthesis model needs to be finely adjusted. Without fine adjustment, low speech quality may be obtained, that is, the source text-to-speech synthesis model usually has poor adaptability to unknown speakers, especially when a reference speech is short.

According to some embodiments of the present disclosure, a method for speech synthesis is provided, which flexibly uses learned speaker's voice features to synthesize a speech, and an improved linear projection is provided to improve the adaptability of a speech synthesis model to unknown speakers.

According to some embodiments of the present disclosure, a high-quality speech is synthesized using the voice of a cloned target speaker, and a good linear projection for speaker's voice features is found utilizing the concept of potential energy. Embedded vectors of the speaker's voice features can be used for speech generation.

According to some embodiments of the present disclosure, a speaker voice feature extractor and an encoder are provided. The potential energy-based method provided can better learn voice features of a speaker in an efficient and lightweight manner.

According to some embodiments of the present disclosure, end-to-end synthesis networks are provided that do not depend on intermediate language features and different speaker embedding feature vector networks that are not limited to a closed speaker set.

According to some embodiments of the present disclosure, an efficient edge end solution architecture is provided, which can make a speech synthesis architecture system have a small computing quantity and a few resource demands, and easily applied to an edge device.

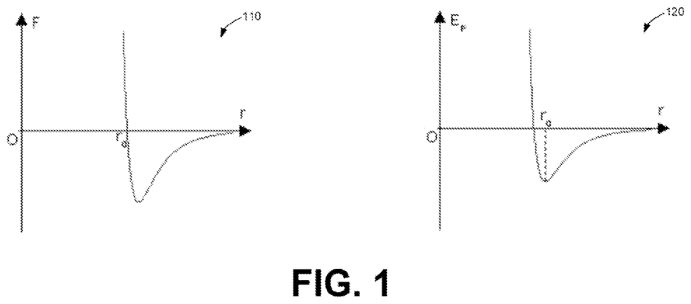

In some embodiments of the present disclosure, a potential energy-based voice cloning algorithm is provided. The concept of potential energy is briefly introduced in combination with FIG. 1. Potential energy is a simple concept in physics. Molecular potential energy is energy between molecules related to a relative position of the molecules due to the presence of a mutual acting force. The potential energy between the molecules is caused by an intermolecular force, so the molecular potential energy is related to the magnitude of the intermolecular mutual force and the relative position of the molecules. The intermolecular force is divided into a repulsive force and a gravitational force. At a balance position, the gravitational force and the repulsive force are relatively balanced. The intermolecular force is manifested as the repulsive force when it is less than the balance position. The intermolecular force is manifested as the gravitational force when it is greater than the balance position. However, the repulsive force and the gravitational force always exist at the same time in any case. The gravitational and repulsive forces between molecules act within a certain distance range. Generally, when an intermolecular distance is greater than 10 times distance ro at the balance position, the intermolecular force becomes very weak and can be ignored.

As shown in FIG. 1, coordinate diagram 110 shows a relationship between an intermolecular resultant force F and a distance r, and coordinate diagram 120 shows a relationship between an intermolecular potential energy E_{P} and a distance r. The distance r is illustratively between two particles, and r₀ is a distance in a stable balance state where resultant force F of a gravitational force and a repulsive force is zero. It can be seen from coordinate diagram 110 and coordinate diagram 120 that when a distance between molecules is greater than balance distance r₀, the resultant force is manifested as the gravitational force. At this time, when the distance between the particles is increased, the force does negative work, and the potential energy increases. When the intermolecular distance is less than the balance distance r₀, the resultant force is manifested as the repulsive force. At this time, when the distance is decreased, the force still does negative work, and the potential energy increases. It can be seen that when the intermolecular distance is equal to balance distance r₀, the resultant force is zero, the potential energy is the smallest, and the state is the most stable. However, the potential energy is not necessarily zero because the potential energy is relative.

In embodiments of the present disclosure, a suitable distance between two voice feature vectors can be found using the concept of potential energy. For example, potential energy is used for optimizing the position of the center of mass so that the center of mass can be easily classified without being too far away, and potential energy is used for optimizing positions of similar features so that they are sufficiently close.

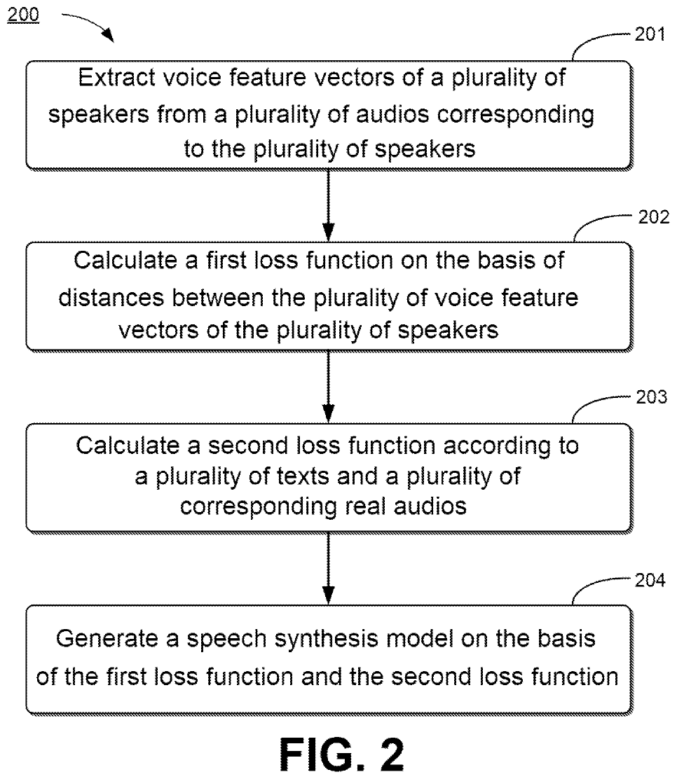

FIG. 2 shows a flow chart of method 200 for speech synthesis according to some embodiments of the present disclosure. Method 200 may be performed by an electronic device. The electronic device may include, but is not limited to, a personal computer (PC), a server computer, a handheld or laptop device, a mobile terminal, a multiprocessor system, a wearable electronic device, a minicomputer, a mainframe, an edge computing device, or a distributed computing environment including any one or a combination of the above devices. Embodiments of the present disclosure do not make any limitation to the device type and the like of the electronic device that implements method 200. It should be understood that, in embodiments of the present disclosure, the electronic device implementing method 200 may be implemented by a single entity device or may be implemented by a plurality of entity devices together. It is understandable that the subject implementing method 200 may be a logical function module in an entity device, or may be a logical function module composed of a plurality of entity devices. It should be understood that, in the following embodiments of the present disclosure, the steps in the method provided in embodiments of the present disclosure may be performed by one entity device, or the steps in the method provided in embodiments of the present disclosure may be performed by a plurality of entity devices cooperatively, which is not limited in embodiments of the present disclosure.

It should be understood that method 200 may also include additional blocks that are not shown and/or may omit blocks that are shown, and the scope of the present disclosure is not limited in this regard.

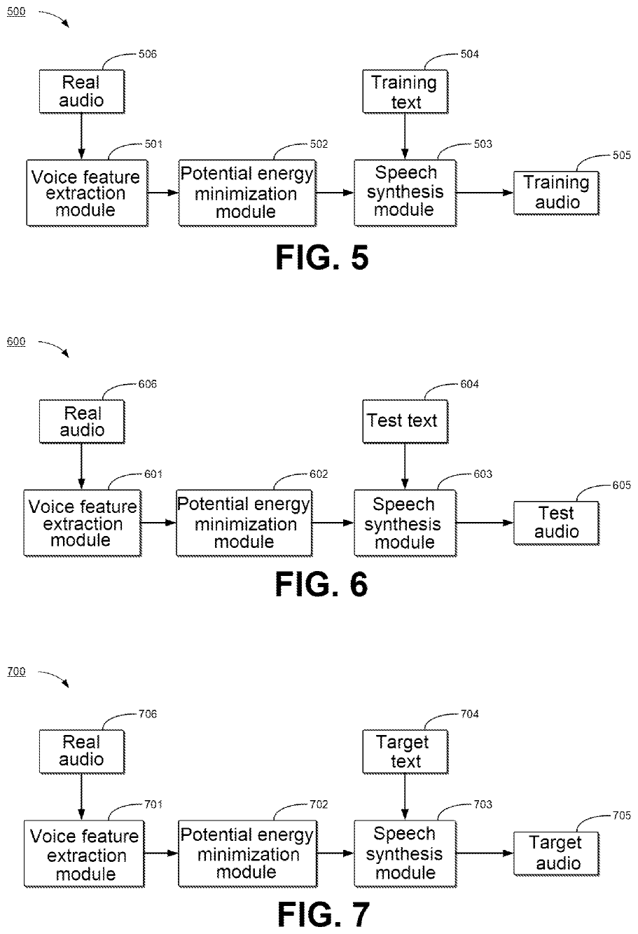

At block 201, voice feature vectors of a plurality of speakers are extracted from a plurality of audios (e.g., respective audio signals) corresponding to the plurality of speakers. In some embodiments, this process can be implemented by voice feature extraction module 501 in training module 500 of FIG. 5. There are many techniques available to extract voice features, and embodiments of the present disclosure are not limited in this regard.

At block 202, a first loss function is calculated based on distances between the plurality of voice feature vectors of the plurality of speakers. In some embodiments, this process can be implemented by potential energy minimization (PEM) module 502 in training module 500 of FIG. 5. The first loss function is illustratively obtained based on a molecular potential energy calculation equation. The first loss function is obtained according to the distance relationship between the plurality of voice feature vectors by applying the molecular potential energy calculation equation.

At block 203, a second loss function is calculated according to a plurality of texts and a plurality of corresponding real audios. In some embodiments, the second loss function is obtained based on a difference between a synthesized audio for the plurality of texts and the plurality of real audios corresponding to the plurality of texts.

At block 204, a speech synthesis model is generated based on the first loss function and the second loss function. In some embodiments, the first loss function and the second loss function can be summarized to obtain a third loss function, and the speech synthesis model can be trained based on minimizing the third loss function to obtain a trained speech synthesis model.

In some embodiments, the distances between the voice feature vectors of the same speaker may be relatively short, and the distances between the voice feature vectors of different speakers may be relatively long, which is convenient to distinguish the voice features of different speakers. For example, the plurality of speakers may include a second speaker and a third speaker; and a first distance between a first voice feature vector and a second voice feature vector for the second speaker is less than a second distance between the first voice feature vector for the second speaker and a third voice feature vector for the third speaker.

By implementing the method, the speech synthesis model can be optimized and trained, so that a high-quality audio with target voice features can be outputted based on the texts. More specific implementation details can be understood in combination with the following embodiments.

After method 200, the speech synthesis model can be obtained. Based on a target text and a target voice feature, the speech synthesis model can be used for audio cloning to generate an audio corresponding to the target text and having the target voice feature.

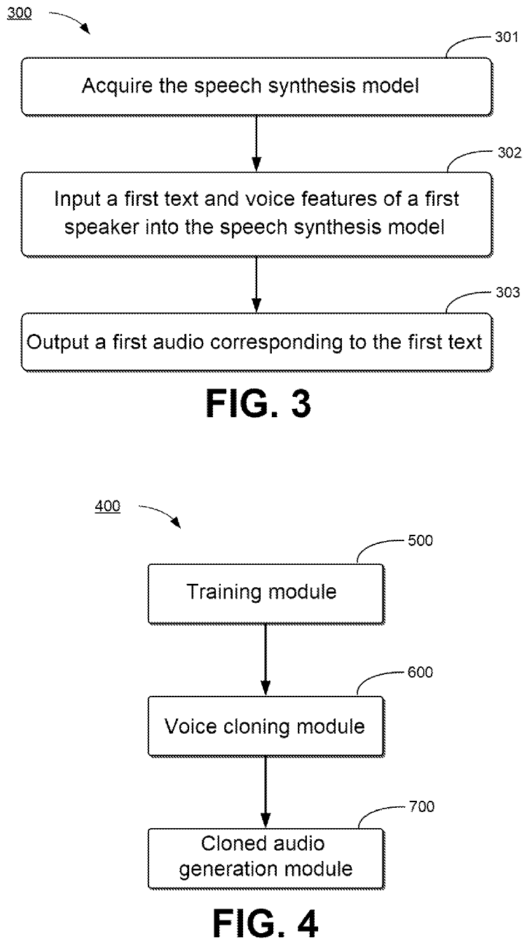

Referring to method 300 shown in FIG. 3, at block 301, a speech synthesis model is acquired. The speech synthesis model can be obtained by using method 200. In some embodiments, the speech synthesis model may be generated by training that occurs in a cloud and is sent to an edge when necessary. At block 302, a first text and voice features of a first speaker are inputted into the speech synthesis model. At block 303, a first audio corresponding to the first text is outputted. In some embodiments, the first audio, corresponding to the first text, for the first speaker may be locally generated.

In some embodiments, the plurality of speakers corresponding to training of the speech synthesis model do not include the first speaker. Method 300 tests whether the speech synthesis model complies with a use standard which may be subjective judgment of a user, or judgment by means of some parameter indicators. Embodiments of the disclosure are not limited in this regard.

In some embodiments, it is determined whether the first audio has the voice features of the first speaker. If the first audio has the voice features of the first speaker, it indicates that the speech synthesis model can be used for synthesizing an audio with the voice features of the first speaker. The speech synthesis model is used for synthesizing a second audio corresponding to a second text, and the second audio has the voice features of the first speaker.

In some embodiments, the above speech synthesis model is referred to as a first speech synthesis model. If it is determined that the first audio does not have the voice features of the first speaker, that is, if the first speech synthesis model is unqualified, a second speech synthesis model is generated based on the voice features of the first speaker, that is, the voice features of the first speaker are added to training samples to retrain the second speech synthesis model. A third audio corresponding to a third text is synthesized using the second speech synthesis model. The third audio has the voice features of the first speaker. Since the voice features of the first speaker are added to the training samples, the quality of the cloned audio outputted using the second speech synthesis model is better than that of the cloned audio outputted using the first speech synthesis model.

FIG. 4 shows a schematic diagram of architecture 400 for speech synthesis according to embodiments of the present disclosure. Architecture 400 includes training module 500, voice cloning module 600, cloned audio generation module 700, and the like. Training module 500 may be configured to train a speech synthesis model based on a plurality of text-audio pairs of a plurality of speakers. Voice cloning module 600 may be configured to test the adaptability of the speech synthesis model to a target speaker. Cloned audio generation module 700 may be configured to generate a target audio with voice features of the target speaker for a target text. By implementing architecture 400, the speech synthesis model can be optimized and trained, so that a high-quality audio with target voice features can be outputted based on the texts.

In some embodiments, training module 500 may be implemented on a cloud server. The cloned audio generation module 700 may be implemented on an edge device. It should be understood that architecture 400 illustrated in FIG. 4 is only schematic. According to actual applications, architecture 400 in FIG. 4 may have other different forms. Architecture 400 may also include a greater or smaller number of one or more functional modules and/or units for speech synthesis. These modules and/or units can be partially or entirely implemented as hardware modules, software modules, firmware modules, or any combination thereof. Embodiments of the present disclosure are not limited in this regard.

Referring to FIG. 5, training module 500 may include voice feature extraction module 501, PEM module 502, speech synthesis module 503, training text 504, training audio 505, real audio 506, and the like. Speech synthesis module 503 is also referred to herein as speech synthesis model 503. In some embodiments, a training text-audio pair for a plurality of speakers, i.e., training text 504 and real audio 506, may be inputted into speech synthesis model 503. Synthesized training audio 505 corresponding to training text 504 is outputted. Speech synthesis model 503 is trained based on a purpose of minimizing a difference between training audio 505 and real audio 506. A trained speech synthesis model is finally generated.

Voice feature extraction module 501 can extract voice feature embedding vectors of the plurality of speakers from a plurality of real audios 506, which can also be referred to as voice feature projection vectors. Embodiments of the present disclosure are not limited in terms of the extraction and projection techniques utilized in the context of the voice feature vectors.

PEM module 502 may receive voice feature embedding vectors of the plurality of speakers from voice feature extraction module 501, optimize the vectors based on the principle of potential energy, and then output the optimized voice feature embedding vectors of the plurality of speakers to speech synthesis model 503.

In some embodiments, in order to convert voice feature distributions into a feasible space, these feature distributions should be more regular, that is, more like Gaussian functions. Therefore, the voice feature distributions can be converted to similar Gaussian distributions before the PEM module 502 performs optimal conversion on the feature vectors. For example, a Tukey power transformation can be used for transforming the features, so that the distribution of the features is more in line with the Gaussian distribution. The Tukey power transformation may be described by Equation (1) below:

$$\\ \begin{matrix}\hat{x} = \{ \begin{matrix}{x}^{{}^{} λ} & if λ \neq 0 \\ log ( x ) & if λ = 0\end{matrix} & ( 1 )\end{matrix}$$

where λ is a hyper-parameter that controls a distribution regularization method. According to Equation (1), in order to restore the feature distribution, λ should be set to 1. If λ decreases, the distribution becomes less positively skewed, and vice versa.

Referring to the previous description of molecular potential energy, balance distance r₀ is the optimal distance that the transformation attempts to reach. Considering that stabilization system F_{S} has linear transformation of weight W_{T} and feature vector F, which satisfies F_{S}=W_{T}F, in some embodiments, in order to achieve this objective, reference may be made to potential energy expressions possibly in different forms. Equation (2) below is used in some examples:

$$\\ \begin{matrix}E = \frac{1}{{r}^{{}^{} 2}} - \frac{1}{{r}^{{}^{} 3}} & ( 2 )\end{matrix}$$

In Equation (2), r represents a distance between two particles, and E represents potential energy. A loss function (also referred to as the first loss function) of the voice feature transformation is then rewritten as shown in Equation (3) below to learn weight W_{T}:

$$\\ \begin{matrix}{L}_{PEM} = {{\sum }^{N}}_{i} {{\sum }^{N - 1}}_{j} [ \frac{1}{{( {d}_{ij} + λ )}^{2}} - \frac{1}{{( {d}_{ij} + λ )}^{3}} ] & ( 3 )\end{matrix}$$

where dᵢⱼ=dis(W_{T}fᵢ, W_{T}fⱼ), dis( ) represents a distance calculation measure, such as an Euclidean distance; N is the number of samples to be compared; and λ is the hyper-parameter that controls the loss function. If it is intended to make the optimal transformation similar to molecular potential energy optimization, λ is set to be a low value, which represents high potential energy (different types of centers of mass); setting λ to a high value represents low potential energy between atoms (the same type of features). In some embodiments, the distances between voice feature vectors of the same speaker may be relatively short, and the distances between voice feature vectors of different speakers may be relatively long, which is convenient to distinguish the voice features of different speakers.

Speech synthesis model 503 is trained based on the inputted voice feature embedding vectors of the plurality of speakers optimized by PEM module 502 and training text 504. In some embodiments, the model f(t_{i,j}, sᵢ; W, eₛ_{ᵢ}) trained for the plurality of speakers can receive text t_{i,j} and speaker identifiers sᵢ. Trainable parameters in f(t_{i,j}, sᵢ; W, eₛ_{ᵢ}) can be parameterized by W and eₛ_{ᵢ}, where eₛ_{ᵢ} represents the voice feature embedding vector of a trainable speaker corresponding to sᵢ. Both W and eₛ_{ᵢ} may be optimized by minimizing loss function L (also referred to as the second loss function). Loss function L is related to a difference between the training audio synthesized by the speech synthesis model for the training text and the real audio (such as a regression loss of the spectrogram). Speech synthesis model 503 may be trained based on Equation (4) below:

$$\\ \begin{matrix}{min}_{W , e} {E}_{{s}_{i} \sim S , ( {t}_{i , j} , {a}_{i , j} ) \sim {𝒯}_{{s}_{i}}} \{ L ( f ( {t}_{i , j} , {s}_{i} ; W , {e}_{{s}_{i}} ) , {a}_{i , j} ) + {L}_{PEM} \} & ( 4 )\end{matrix}$$

where S is a speaker set; [symbol] ₛ_{ᵢ} is a text-audio pair training set of speaker sᵢ; and a_{i,j} is a real audio of speaker sᵢ for t_{i,j}. Expected E in Equation (4) may be estimated by the text-audio pairs of all the training speakers. Speech synthesis model 503 may be trained based on the minimization of expected E which can include the sum (which is also referred to as third loss function) of the first loss function and the second loss function. Ŵ represents a parameter after training, and ê represents a voice feature embedding vector after training. The voice feature embedding vectors of the speakers can effectively capture the voice features of low-dimensional vector speakers, and can distinguish recognizable attributes in a speaker embedding space, such as gender and accent. It can be understood that embodiments of the present disclosure include using other forms of loss functions to train the network. The scope of the present disclosure is not limited in this regard.

Referring to FIG. 6, voice cloning module 600 may include voice feature extraction module 601, PEM module 602, speech synthesis module 603, test text 604, test audio 605, real audio 606, and the like. Speech synthesis module 603 is also referred to herein as speech synthesis model 603. Speech synthesis model 603 used here is a trained speech synthesis model, such as an available speech synthesis model trained by training module 500. Voice cloning module 600 is configured to test whether the trained speech synthesis model is available for a target speaker. The specific implementation of voice feature extraction module 601 and PEM module 602 can refer to the foregoing description.

To adapt to and clone the voice of an unknown speaker, the trained speech synthesis model for the plurality of speakers can be finely adjusted by using some audio-text pairs, so as to adapt to the unknown speaker and clone an audio with the voice features of the unknown speaker. Fine adjustment can be applied to the voice feature embedding vectors or the entire model. For the adjustment that only adapts to the voice feature embedding vectors, its training objective refers to Equation (5) below:

$$\\ \begin{matrix}{min}_{{e}_{{s}_{k}}} {𝔼}_{( {t}_{k , j} , {a}_{k , j} ) \sim {𝒯}_{{s}_{k}}} \{ L ( f ( {t}_{k , j} , {s}_{k} ; \hat{W} , {e}_{{s}_{k}} ) , {a}_{k , j} ) \} & ( 5 )\end{matrix}$$

where [symbol] ₛ_{ₖ} is a group of text-audio pairs for the target speaker sₖ. For the adjustment that adapts to the whole model, its training objective refers to Equation (6) below:

$$\\ \begin{matrix}{min}_{W , {e}_{{s}_{k}}} {𝔼}_{( {t}_{k , j} , {a}_{k , j} ) \sim {𝒯}_{{s}_{k}}} \{ L ( f ( {t}_{k , j} , {s}_{k} ; W , {e}_{{s}_{k}} ) , {a}_{k , j} ) \} & ( 6 )\end{matrix}$$

Although the whole model provides a larger degree of freedom for the self-adaption of unknown speakers, due to a small data volume of cloning, optimizing the model is challenging, and will be stopped as soon as possible to avoid overfitting. Compared with a traditional speech cloning framework, the PEM module 602 is almost non-parametric and can achieve good results for speech synthesis, which enables the test and application of speech synthesis to be deployed on the edge device.

In some embodiments, a plurality of real audios [symbol] ₛ_{ₖ} of an unknown speaker are inputted. The unknown speaker is the target speaker (also referred to the first speaker). The unknown speaker does not participate in the previous training of the speech synthesis model, that is, the plurality of speakers trained in the trained speech synthesis model do not include the unknown speaker. Voice feature extraction module 601 can extract the voice feature embedding vectors of unknown speaker sₖ from the inputted group of real audios 606. After being optimized by PEM module 602, the optimized voice feature embedding vectors and test text 604 (such as the first text) are inputted into speech synthesis model 603, and test audio 605 (such as the first audio) of the unknown speaker corresponding to given test text 604 is outputted. Later, test audio 605 is compared with target audio to determine whether speech synthesis model 603 complies with the standard for generating the audio for the unknown speaker based on the text. For example, determining indicators may be the naturalness of a speech and a similarity with the voice of the speaker, that is, whether the generated test audio sounds like the voice of the target speaker. Embodiments of the present disclosure do not limit the setting of the determining standard, the determining techniques, and the like.

In some embodiments, if speech synthesis model 603 (also referred to as the first speech synthesis model) meets a set standard, the speech synthesis model can be applied to cloned audio generation module 700 to generate a target audio (such as the second audio) for the target speaker based on the target text (such as the second text). In other embodiments, if speech synthesis model 603 does not meet the set standard, a plurality of real audios 606 of the unknown speaker can be inputted into training module 500 to retrain the speech synthesis model. The retrained speech synthesis model (also referred to as the second speech synthesis model) is then applied to the cloned audio generation module to generate a target audio (such as the third audio) for the target speaker based on the target text (such as the third text). In some embodiments, since the voice features of the target speaker are added to the retraining samples, the quality of the cloned audio outputted by the retrained speech synthesis model is higher than that of the cloned audio outputted by former speech synthesis model 603, and the high-quality cloned audio is more in line with the voice features of the target speaker.

Referring to FIG. 7, cloned audio generation module 700 may include voice feature extraction module 701, PEM module 702, speech synthesis module 703, target text 704, target audio 705, real audio 706, and the like. Speech synthesis module 703 is also referred to herein as speech synthesis model 703. Cloned audio generation module 700 is configured to be applied to text-audio synthesis for the target speaker. Speech synthesis model 703 is a model that can be applied and has a good effect. Real audio 706 is inputted into voice feature extraction module 701. Voice feature extraction module 701 extracts the voice feature embedding vectors of the target speaker.

After being optimized by PEM module 702, the optimized voice feature embedding vectors and target text 704 are inputted into speech synthesis model 703, and target audio 705 for the target speaker and corresponding to given target text 704 is outputted. The target audio 705 has the voice features of the target speaker. Since speech synthesis model 703 has been verified to be well adapted to the voice synthesis of the target speaker, real audio 706 may be a small number of audios. The specific implementation of voice feature extraction module 701 and PEM module 702 can refer to the foregoing description.

It can be seen that the voice generation networks of training module 500, voice cloning module 600, and cloned audio generation module 700 are all end-to-end synthesis networks. Intermediate processing for distinguishing language features is not required, but a speech synthesis model is directly trained based on the inputted text-audio pairs, which can save much time and reduce the dependence on language recognition. It can be understood that compared with a traditional speech cloning framework, the PEM module 702 is almost non-parametric and can achieve good results for speech synthesis, which can enable voice cloning module 600 and/or cloned audio generation module 700 for speech synthesis to be deployed on the edge device. Training module 500 which consumes significant amounts of processing resources can be deployed in the cloud, and the trained speech synthesis model can be sent to the edge device, so that the processing resources and processing capabilities in the architecture can be reasonably allocated.

In embodiments of the present disclosure, a good linear projection for the voice features of a speaker can be improved based on the concept of potential energy, so that high-quality speeches are synthesized by flexibly using the learned features of the speaker to improve the adaptability of the speech synthesis model to unknown speakers. The potential energy-based method provided by embodiments of the present disclosure can better learn voice features of speakers in an efficient and lightweight manner by using an end-to-end synthesis network that does not rely on intermediate language features and different speaker embedding feature vector networks that are not limited to a closed set of speakers. According to embodiments of the present disclosure, an efficient edge solution architecture is provided, which can make a speech synthesis architecture system have a small computing quantity and low resource demands, and easily applied to an edge device.

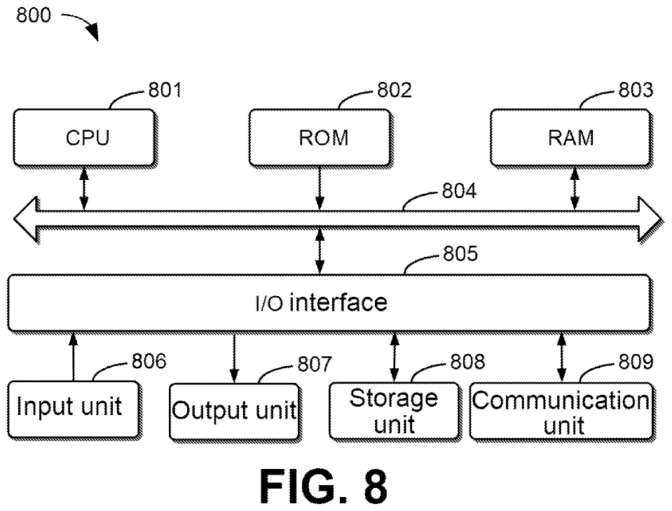

FIG. 8 shows a block diagram of example device 800 that can be configured to implement some embodiments of the present disclosure. Device 800 may be a server or an edge device. Embodiments of the present disclosure do not limit a specific implementation type of device 800. As shown in FIG. 8, device 800 includes Central Processing Unit (CPU) 801, which may execute various appropriate actions and processing in accordance with computer program instructions stored in Read-Only Memory (ROM) 802 or computer program instructions loaded onto Random Access Memory (RAM) 803 from storage unit 808. Various programs and data required for the operation of device 800 may also be stored in RAM 803. CPU 801, ROM 802, and RAM 803 are connected to each other through bus 804. Input/Output (I/O) interface 805 is also connected to bus 804.

A plurality of components in device 800 are connected to I/O interface 805, including: input unit 806, such as a keyboard and a mouse; output unit 807, such as various types of displays and speakers; storage unit 808, such as a magnetic disk and an optical disc; and communication unit 809, such as a network card, a modem, and a wireless communication transceiver. Communication unit 809 allows device 800 to exchange information/data with other devices via a computer network, such as the Internet, and/or various telecommunication networks.

CPU 801 may perform the various methods and/or processing described above, such as method 200 or method 300. For example, in some embodiments, method 200 or method 300 may be implemented as a computer software program that is tangibly included in a machine-readable medium such as storage unit 808. In some embodiments, part or all of the computer program may be loaded and/or installed onto device 800 via ROM 802 and/or communication unit 809. When the computer program is loaded to RAM 803 and executed by CPU 801, one or more steps of method 200 or method 300 described above may be performed. Alternatively, in other embodiments, CPU 801 may be configured to perform method 200 or method 300 in any other suitable manners (e.g., by means of firmware).

The functions described above may be performed, at least in part, by one or a plurality of hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Complex Programmable Logic Device (CPLD), and the like.

In some embodiments, the methods and processes described above may be implemented as a computer program product. The computer program product may include a computer-readable storage medium on which computer-readable program instructions for performing various aspects of the present disclosure are loaded.

Program code for implementing the method of the present disclosure may be written by using one programming language or any combination of a plurality of programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code can be completely executed on a machine, partially executed on a machine, partially executed on a machine as an independent software package and partially executed on a remote machine, or completely executed on a remote machine or a server.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams. The computer-readable program instructions may also be loaded to a computer, other programmable data processing apparatuses, or other devices, so that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disk read-only memory (CD-ROM), an optical storage device, a magnetic storage device, or any suitable combinations thereof.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, and the module, program segment, or part of an instruction includes one or more executable instructions for implementing specified logical functions. In some alternative implementations, functions marked in the blocks may also occur in an order different from that marked in the accompanying drawings. For example, two consecutive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

Various embodiments of the present disclosure have been described above. The foregoing description is illustrative rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the various embodiments disclosed herein.

What is claimed is:

1. A method for speech synthesis, the method comprising:
extracting a plurality of voice feature vectors of a plurality of speakers from a plurality of audios corresponding to the plurality of speakers;
calculating a first loss function based on distances between the plurality of voice feature vectors of the plurality of speakers;
calculating a second loss function according to a plurality of texts and a plurality of corresponding real audios; and
generating a speech synthesis model based on the first loss function and the second loss function.

2. The method according to claim 1, wherein the calculating a second loss function according to a plurality of texts and a plurality of corresponding real audios comprises:
obtaining the second loss function based on a difference between a synthesized audio for the plurality of texts and the plurality of real audios corresponding to the plurality of texts.

3. The method according to claim 1, wherein the generating a speech synthesis model based on the first loss function and the second loss function comprises:
summarizing the first loss function and the second loss function to obtain a third loss function; and
generating the speech synthesis model based on minimizing the third loss function.

4. The method according to claim 1, further comprising:
inputting a first text and voice features of a first speaker into the speech synthesis model; and
outputting a first audio corresponding to the first text.

5. The method according to claim 4, wherein the plurality of speakers corresponding to training of the speech synthesis model do not comprise the first speaker.

6. The method according to claim 4, further comprising:
determining whether the first audio has the voice features of the first speaker; and
synthesizing, if the first audio has the voice features of the first speaker, a second audio corresponding to a second text using the speech synthesis model, the second audio having the voice features of the first speaker.

7. The method according to claim 6, wherein the speech synthesis model is a first speech synthesis model, and the method further comprises:
generating a second speech synthesis model based on the voice features of the first speaker if the first audio does not have the voice features of the first speaker; and
synthesizing a third audio corresponding to a third text using the second speech synthesis model, the third audio having the voice features of the first speaker.

8. The method according to claim 4, wherein the speech synthesis model is generated by training at a cloud, and the first audio, corresponding to the first text, for the first speaker is locally generated.

9. The method according to claim 1, wherein the plurality of speakers comprise a second speaker and a third speaker; and a first distance between a first voice feature vector and a second voice feature vector for the second speaker is less than a second distance between the first voice feature vector for the second speaker and a third voice feature vector for the third speaker.

10. An electronic device for speech synthesis, comprising:
a processor; and
a memory coupled to the processor and having instructions stored therein, wherein the instructions, when executed by the processor, cause the electronic device to perform actions comprising:
extracting a plurality of voice feature vectors of a plurality of speakers from a plurality of audios corresponding to the plurality of speakers;
calculating a first loss function based on distances between the plurality of voice feature vectors of the plurality of speakers;
calculating a second loss function according to a plurality of texts and a plurality of corresponding real audios; and
generating a speech synthesis model based on the first loss function and the second loss function.

11. The electronic device according to claim 10, wherein the calculating a second loss function according to a plurality of texts and a plurality of corresponding real audios comprises:
obtaining the second loss function based on a difference between a synthesized audio for the plurality of texts and the plurality of real audios corresponding to the plurality of texts.

12. The electronic device according to claim 10, wherein the generating a speech synthesis model based on the first loss function and the second loss function comprises:
summarizing the first loss function and the second loss function to obtain a third loss function; and
generating the speech synthesis model based on minimizing the third loss function.

13. The electronic device according to claim 10, wherein the actions further comprise:
inputting a first text and voice features of a first speaker into the speech synthesis model; and
outputting a first audio corresponding to the first text.

14. The electronic device according to claim 13, wherein the plurality of speakers corresponding to training of the speech synthesis model do not comprise the first speaker.

15. The electronic device according to claim 13, wherein the actions further comprise:
determining whether the first audio has the voice features of the first speaker; and
synthesizing, if the first audio has the voice features of the first speaker, a second audio corresponding to a second text using the speech synthesis model, the second audio having the voice features of the first speaker.

16. The electronic device according to claim 15, wherein the speech synthesis model is a first speech synthesis model, and the actions further comprise:
generating a second speech synthesis model based on the voice features of the first speaker if the first audio does not have the voice features of the first speaker; and
synthesizing a third audio corresponding to a third text using the second speech synthesis model, the third audio having the voice features of the first speaker.

17. The electronic device according to claim 13, wherein the speech synthesis model is generated by training at a cloud, and the first audio, corresponding to the first text, for the first speaker is locally generated.

18. The electronic device according to claim 10, wherein the plurality of speakers comprise a second speaker and a third speaker; and a first distance between a first voice feature vector and a second voice feature vector for the second speaker is less than a second distance between the first voice feature vector for the second speaker and a third voice feature vector for the third speaker.

19. A computer program product tangibly stored in a non-transitory computer-readable medium and comprising machine-executable instructions, wherein the machine-executable instructions, when executed by a machine, cause the machine to perform a method for speech synthesis, the method comprising:
extracting a plurality of voice feature vectors of a plurality of speakers from a plurality of audios corresponding to the plurality of speakers;
calculating a first loss function based on distances between the plurality of voice feature vectors of the plurality of speakers;
calculating a second loss function according to a plurality of texts and a plurality of corresponding real audios; and
generating a speech synthesis model based on the first loss function and the second loss function.

20. The computer program product according to claim 19, wherein the calculating a second loss function according to a plurality of texts and a plurality of corresponding real audios comprises:
obtaining the second loss function based on a difference between a synthesized audio for the plurality of texts and the plurality of real audios corresponding to the plurality of texts.
